(19) United States
(12) Patent Application Publication
(10) Pub. No.: US 2019/0249004 A1
(43) Pub. Date: Aug. 15, 2019

(54) FLAME-RETARDED POLYESTER COMPOSITIONS

(71) Applicant: BROMINE COMPOUNDS LTD., Beer Sheva (IL)

(72) Inventors: Yaniv HIRSCHSOHN, Rehovot (IL); Eyal EDEN, Shoham (IL); Yelena EPSHTEIN ASSOR, Beer-Sheva (IL); Shay DICHTER, Meitar (IL)

(73) Assignee: BROMINE COMPOUNDS LTD., Beer Sheva (IL)

(21) Appl. No.: 16/342,434

(22) PCT Filed: Oct. 17, 2017
(86) PCT No.: PCT/IL2017/051142

§ 371 Date: Apr. 16, 2019

Related U.S. Application Data
(60) Provisional application No. 62/409,399, filed on Oct. 18, 2016.

(51) Int. Cl. C08L 67/02

(52) U.S. Cl. CPC C08L 67/02; C08L 2310/00; C08L 2205/03; C08L 2201/02

(57) ABSTRACT

A composition comprising polyester and a mixture of flame retardants having at least the following two components: calcium hypophosphite and bromine-containing polymer.

Glass-fiber reinforced poly(1,4-butylene terephthalate), hereinafter abbreviated PBT/GF, is used in various insulating parts for electrical and electronic devices. The commonly used grades are generally reinforced with 30 wt % glass fibers based on the total weight of the composition (hereinafter abbreviated PBT/GF₃₀).

Many polymers in commercial use contain flame retardants to reduce their flammability and PBT/GF is no exception to this rule. PBT/GF, e.g., PBT/GF₃₀, is more difficult to flame retard than the non-reinforced polymer. The flammability characteristics of plastic materials are usually quantifiable according to a method specified by Underwriter Laboratories standard UL 94, where an open flame is applied to the lowermost edge of a vertically mounted test specimen made of the tested polymer formulation. The specimens used in the UL 94 test method vary in thickness (typical thicknesses are ˜3.2 mm, ˜1.6 mm, ˜0.8 mm and ˜0.4 mm). During the test, various features of the flammability of the test specimens are recorded. Then, according to the classification requirements, the polymer formulation is assigned with either V-0, V-1 or V-2 rating at the measured thickness of the test specimen. Polymer formulation assigned with the V-0 rating is the less flammable. Furthermore, in the UL-94 burning test, the thinner the specimens are, the longer the burning time. Therefore, the requirements of UL 94 V-0 rating for thin PBT/GF₃₀ test specimens (e.g., 0.8 or 0.4 mm thick samples) are not easily met.

Metal salts of hypophosphorous acid, that is, metal hypophosphite, have been found to be effective flame retardants in polyesters, with the predominance of literature focusing on aluminum hypophosphite. In U.S. Pat. No. 7,700,680 it was shown that aluminum hypophosphite, Al(H₂PO₂)₃, can be used in PBT/GF, in combination with melamine cyanurate. Yet, the experimental results reported in Table 2 of U.S. Pat. No. 7,700,680 suggest that the aforementioned combination does not fulfill the requirements of UL 94 V-0 rating for thin PBT/GF₃₀ specimens (e.g., 0.8 mm or 0.4 mm). UL 94 V-0/0.8 mm rating was reported for PBT/GF₃₀ with the aid of a ternary system consisting of Al(H₂PO₂)₃, melamine cyanurate and polycarbonate as a charring agent with 10 wt %, 10 wt % and 7.5 wt % loadings, respectively—see Yang et al. [Industrial & Engineering Chemistry Research 50, p. 11975-11981 (2011)]. Chen et al. [Polymer Degradation and Stability 97, p. 158-165 (2012)] reported that Al(H₂PO₂)₃ is able to secure UL 94 V-0/1.6 mm rating for PBT/GF₃₀ as a sole flame retardant additive at a concentration of 25% by weight. As to other metal hypophosphite salts, calcium hypophosphite Ca(H₂PO₂)₂ is mentioned in U.S. Pat. No. 6,503,969 (in the name BASF) and WO 2012/113146 (in the name of Rhodia).

There exists a need for a suitable system of flame retardants to effectively reduce the flammability of thin polyester parts, especially thin PBT/GF₃₀ parts, that is, where the thickness of the test specimen is 0.8 mm or less. We have now found that calcium hypophosphite in combination with bromine-containing polymers fulfill the UL 94 V-0 requirements for such thin PBT/GF₃₀-made parts used in electrical engineering and electronics applications (that is, UL 94 V-0/0.8 mm and preferably also UL 94 V-0/0.4 mm). Notably, polyesters such as PBT/GF₃₀ can be flame retarded with the aid of the aforementioned mixture even in the absence of antimony trioxide [Normally bromine-containing flame retardants are added to plastic polymers together with antimony trioxide, which functions synergistically to enhance the activity of the flame retardant, usually at about 2:1-5:1 weight ratio (calculated as the ratio between the concentrations of bromine supplied by the flame retardant and Sb₂O₃ in the polymer composition).

Another method used for evaluating the flammability of polyester compositions of the invention is based on measuring their Glow Wire Ignition Temperature (GWIT). GWIT is the lowest temperature at which a material ignites and burns for longer than 5 seconds under the glow wire test (IEC 60695-2-13 standard). For some preferred polyester compositions of the invention the GWIT measured was above 800° C., and even above 850° C. (GWIT>870° C., e.g., from 870-900° C. (for plate test thickness of 3 mm)).

The polyester compositions of the invention were also investigated to determine their electrical properties by measuring their resistance to exposure of voltage. This property is quantified using the Comparative Tracking Index (CTI), which is a measure of the susceptibility of solid insulating materials to surface tracking when exposed to an electrolyte under the application of voltage. CTI indicates the voltage which causes the sample to undergo carbonization. The higher the CTI, the better is the resistance of the sample to electrical discharge etc. The experimental results reported below indicate that compositions of the invention possess acceptable CTI, above 400 V, e.g., above 420 V, for example, from 430 to 600 V, e.g., from 500 to 600 V (when measured according to IEC 60112 with standard “Solution A”; see below).

The present invention is therefore primarily directed to a composition comprising polyester and a mixture of flame retardants having at least the following two components: A) calcium hypophosphite and B) bromine-containing polymer.

The composition of the invention is substantially Sb₂O₃-free. By “substantially Sb₂O₃-free” is meant that the concentration of antimony trioxide in the composition is well below the acceptable amount used in plastic composites in conjunction with halogenated additives, e.g., not more 1.0% by weight, more preferably, up 0.5% by weight, e.g., 0.0-0.3% by weight (based on the total weight of the composition). Most preferably, the compositions of the invention are totally devoid of antimony trioxide.

The concentration of the mixture of flame retardants in the polyester composition is preferably from 10 to 30% by weight, more specifically from 15 to 25% by weight, for example 17 to 23% by weight based on the total weight of the composition, and the mixture is proportioned such that the ratio between the weight concentrations of bromine (supplied by the brominated additive) and calcium hypophosphite is preferably not less than 1:1, e.g., from 1.05 to 2.0, e.g., from 1.05 to 1.8 (in favor of bromine). The concentration of bromine in the polyester composition is calculated by multiplying the bromine content of the flame retardant (designated herein Br Fr name and expressed as wt %) by the weight concentration of that flame retardant in the polyester composition, as illustrated below.

The first component of the additive mixture is calcium hypophosphite. This salt is available on the market from various manufacturers. The salt can be prepared by the reaction of calcium carbonate or oxide with H₃PO₂, followed by evaporation of the solvent and recovery of the salt (see Encyclopedia of the Alkaline Earth. Compounds by R. C. Ropp; 2013 Elsevier). Other methods are described in U.S. Pat. No. 2,938,770, based on the treatment of sodium hydroxide with an ion exchange resin. Production of calcium hypophosphite is also described in CN 101332982.

The second component of the additive mixture is a bromine-containing polymer. Different types of bromine-containing polymers can be used in combination with Ca(H₂PO₂)₂ according to the present invention, for example:

i) Poly (pentabromobenzyl acrylate), represented by the following formula:

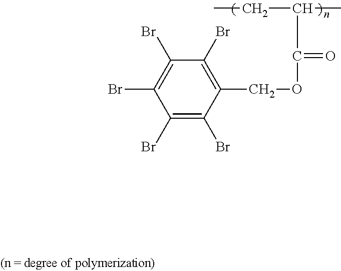

The polymer (abbreviated PBBPA) is produced by polymerizing the corresponding monomer pentabromobenzyl acrylate, either in bulk (in an extruder at a temperature in the range from 120° C. to 290° C. as described in U.S. Pat. No. 4,996,276), or in solution, see U.S. Pat. No. 4,128,709 or 6,028,156. The polymer is also available on the market, being sold by ICL-IP (FR-1025).

ii) Brominated polystyrene, represented by the following formula:

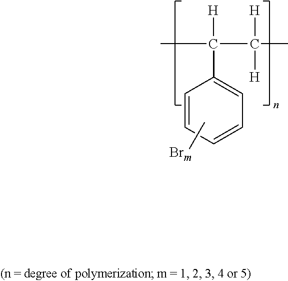

The polymer is prepared by methods known in the art (see U.S. Pat. Nos. 4,879,353 and 5,532,322). Suitable grades have weight average molecular weight in the range of about 500,000-600,000, with bromine content preferably exceeding 60 or even 65% by weight (that is, average of 2-3 bromine atoms per aromatic ring in the polymer backbone chain). Such polymers, in the form of a free flowing powder or in granular form, are available on the market, e.g., from ICL-IP (FR 803P).

iii) brominated epoxy resins and end-capped derivatives thereof, represented by the Formula (I):

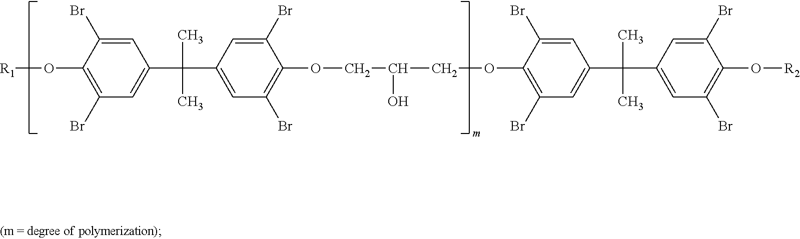

wherein R₁ and R₂ are independently selected from the group consisting of the following:

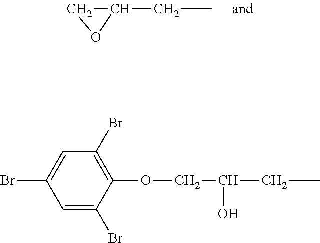

Preferred are epoxy-terminated resins (that is, resin having glycidyl end groups) represented by Formula (Ia):

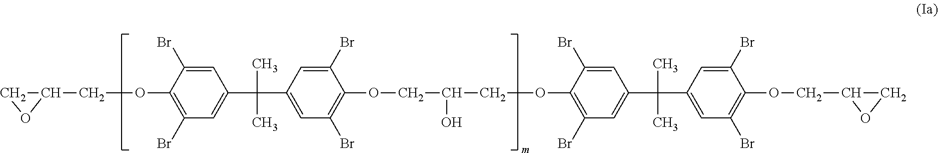

with weight-average molar mass between 2500 and 30000, preferably from 15000 to 25000. The epoxy resins are obtainable by reacting tetrabromobisphenol A with epichlorohydrin. Commercially available examples include F-2100 from ICL-IP, with molecular weight of about 20,000.

The composition of the invention comprises not less than 10% by weight, e.g., from 20 to 70% by weight and preferably from 20 to 60% by weight of a thermoplastic polyester (e.g., 35-55%), in particular polyesters of the classes based on:

aromatic dicarboxylic acids and aliphatic dihydroxy compounds; and

aromatic dicarboxylic acids and aromatic dihydroxy compounds.

Of the former class, preferred are linear polyesters obtained from terephthalic acid, isophthalic acid and 2,6 naphathalenedicarboxylic acid, wherein the aliphatic dihydroxy compound is a diol having from 2 to 6 carbon atoms, such as 1,2-ethanediol, 1,3-propanediol, 1,4-butanediol, 1,6-hexanediol, 1,4-hexanediol, and mixtures thereof. Particularly preferred are polyalkylene terephthalates derived from alkanediols having from 2 to 6 carbon atoms. Among these, especially preferred are polyethylene terephthalate (PET) and polybutylene terephthalate (PBT). Copolymers and/or polyblends available in the market for many linear polyesters are also contemplated for use in the invention. Additional details regarding suitable polyesters can be found in U.S. Pat. Nos. 6,503,969 and 8,188,172. PBT is available from various manufacturers, e.g., BASF and Ticona. For example, the melt flow index of the PBT (MFI; ISO 1133 250° C./2.16 kg) may vary from 25 g/10 min to 50 g/10 min, e.g., from 20 to 35 g/10 min or from 35 to 50 g/10 min.

The composition of the invention preferably comprises reinforcing filler, especially glass fibers, which are usually pre-coated by manufacturers in order to improve their compatibility with the polymer in question (e.g., polyester in the present case). The major constituents of glass fibers applied for reinforcing polyester intended for use in electrical devices are alumino-borosilicates; such type of glass in known as E-glass. The glass fibers comprise filaments with diameter in the range from 1μ to 30μ, and are applied in the form of chopped strands with length in the range from 2 to 10 mm, e.g., from 3 to 4.5 mm. The concentration of the glass fibers is usually from 5% to 40% by weight, e.g., from 10 to 40% by weight, preferably at least 20% by weight, e.g. from 20 to 35% by weight, in particular from 24 to 35% by weight and especially from 27 to 33% by weight, i.e., around 30% by weight, based on the total weight of the composition. The preferred compositions of the invention are therefore designated PBT/GF₂₀₋₃₅, PBT/GF₂₄₋₃₅ and PBT/GF₂₇₋₃₃, in particular, the aforementioned PBT/GF₃₀.

The invention specifically provides a composition comprising: from 20 to 60% by weight of a polyester (e.g., 35-55%), in particular polyalkylene terephthalate, and especially polybutylene terephthalate (PBT);

from 20 to 35% by weight of a reinforcing filler, in particular glass fibers (e.g., 24-35% and especially 27-33%); and

a mixture of flame retardants comprising calcium hypophosphite and bromine-containing polymer selected from the group consisting of poly (pentabromobenzyl acrylate), brominated polystyrene and brominated epoxy resin of Formula (Ia), wherein the concentration of said calcium hypophosphite is preferably in the range from 5% to 10% (e.g., 6 to 9%) by weight based on the total weight of the composition, and the concentration of the bromine-containing polymer is adjusted such that the bromine concentration of the composition is from 7.0 to 12% (e.g., 8 to 11%) by weight based on the total weight of the composition.

The concentration of bromine in the composition is calculated by multiplying the bromine content of a given flame retardant (designated herein Br Fr name and expressed as % by weight) by the weight concentration of that flame retardant in the composition. For example, the bromine contents of commercially available FR-1025, FR-803P and F-2100 are Br_{FR-1025}=71%, Br_{FR-803P}=66% and Br_{F-2100}=52%, respectively. Therefore, to incorporate 10% by weight bromine into the polyester composition, the corresponding concentrations of these three flame retardants should be 14.1%, 15.1% and 19.3% (by weight relative to the total weight of the composition).

The compositions according to the present invention also include one or more anti-dripping agents such as polytetrafluoroethylene (abbreviated PTFE) in a preferred amount between 0.1 and 1.0 wt %, more preferably between 0.3 and 0.7 wt %, and even more preferably between 0.3 and 0.5 wt %, based on the total weight of the composition. PTFE is described, for example, in U.S. Pat. No. 6,503,988.

For example, compositions comprising:

from 40 to 55% by weight of PBT (e.g., 45 to 55%), from 20 to 35% by weight of glass fibers (e.g., 27 to 33%), from 5 to 10% (e.g., 6 to 9%) by weight of Ca(H₂PO₂)₂, from 12 to 15% by weight of poly (pentabromobenzyl acrylate) and from 0.1 to 1.0% (e.g., 0.3 to 0.7%) by weight of PTFE; or

from 40 to 55% by weight of PBT (e.g., 45 to 55%), from 20 to 35% by weight of glass fibers (e.g., 27 to 33%), from 5 to 10% by weight of Ca(H₂PO₂)₂ (e.g., 6 to 9%), from 12 to 18% by weight of brominated polystyrene and from 0.1 to 1.0% by weight of PTFE (e.g., 0.3 to 0.7%); or

from 40 to 50% by weight of PBT (e.g., 40 to 45%), from 20 to 35% by weight of glass fibers (e.g., 27 to 33%), from 5 to 10% by weight of Ca(H₂PO₂)₂ (e.g., 6 to 9%), from 15 to 20% by weight of brominated epoxy resin of Formula (I) or (Ia) and 0.1 to 1.0% by weight of PTFE (e.g., from 0.3 to 0.7%);

were found to possess the desired flammability properties, that is, fulfilling the requirements for UL 94 V-0/0.8 mm rating (and in some cases also UL 94 V-0/0.4 mm rating).

Hence, preferred compositions are characterized in that they achieve a UL-94 flammability test rating of V-0 at a thickness equal to 0.8 mm, and when tested in accordance with IEC 60112 standard using 0.1% by weight NH₄Cl solution and platinum electrodes, the comparative tracking index (CTI) measured is 400 V or more, as mentioned above.

In general, good results are obtained when the mixture of flame retardants used consists solely of calcium hypophosphite and a bromine-containing polymer, devoid of other flame retardants. But in some embodiments, one or more auxiliary flame retardants may be added to the composition, in particular, phosphorous-containing flame retardants, e.g., phosphate esters.

For example, an aryl phosphate ester of hydroquinone (1,4-dihydroxybenzene) of Formula (II):

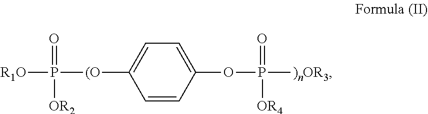

wherein R¹, R², R³ and R⁴ each independently is aryl (e.g., phenyl) or alkyl-substituted aryl (e.g., xylenyl), optionally interrupted with heteroatoms, and n has an average value of from about 1.0 to about 2.0, may be used. The compounds of Formula (II) are described in EP 2089402. In general, the hydroquinone bis-phosphates of Formula II are prepared by reacting a diaryl halophosphate with hydroquinone in the presence of a catalyst. For example, diphenylchlorophosphate (DPCP) is reacted with hydroquinone in the presence of MgCl₂ to produce hydroquinone bis-(diphenyl phosphate). Detailed methods for synthesizing compounds of Formula (II) can be found in EP 2089402. One preferred compound of Formula (II) to be used in this invention has R₁=R₂=R₃=R₄=phenyl and 1.0<n≤1.1, that is, hydroquinone bis(diphenyl phosphate) with an n average value of about 1.0<n≤1.05. The compound is obtainable in a solid form, see Example 1 of EP 2089402. Hereinafter it is named “HDP” for the purpose of simplicity. It is available on the market from ICL-IP in the form of pastilles; the pastilles, when compounded with thermoplastics, avoid various handling problems as well as impart improved thermal properties, such as resin flow.

Another phosphate ester flame retardant that can be added to the polyester composition of the invention is resorcinol bis (diphenyl phosphate), which is a liquid bis-phosphate available from ICL-IP (CAS no.: 57583-54-7; Fyrolflex® RDP). Hereinafter it is named “RDP” for the purpose of simplicity.

Phosphate ester flame retardants such as HDP or RDP can be used to replace part of the amount Ca(H₂PO₂)₂ in the polyester compositions of the invention, namely, in PBT/GF, e.g., to modify mechanical properties. For example, when the bromine-containing polymer is added in amount sufficient to supply 10% by weight bromine content in PBT/GF, then either combination of Ca(H₂PO₂)₂ and HDP {indicated [Ca(H₂PO₂)₂+BDP]}, or a combination of Ca(H₂PO₂)₂ and RDP {indicated [Ca(H₂PO₂)₂+RDP]}, can be added at a total concentration from 5 to 10% based on the total weight of the composition. The weight ratio Ca(H₂PO₂)₂:HDP and likewise the weight ratio Ca(H₂PO₂)₂:RDP can be from 5:1 to 1:5, e.g., from 1:1 to 1:3. An illustrative composition of this embodiment of the invention is a composition comprising from 40 to 55% by weight of PBT, from 20 to 35% by weight of glass fibers (e.g., 27 to 33%), from 12 to 15% by weight of bromine-containing polymer such as poly (pentabromobenzyl acrylate); from 5 to 10% (e.g., 6-9%) by weight of [Ca(H₂PO₂)₂+HDP/RDP)] and from 0.1 to 1.0% by weight of PTFE (e.g., 0.3-0.7%).

Apart from a polyester, a reinforcing filler, a mixture of flame retardants and an anti-dripping agent, the composition of this invention may further contain conventional additives, such as UV stabilizers (e.g., benzotriazole derivative), processing aids, antioxidants (e.g., hindered phenol type), lubricants, pigments, dies and the like. The total concentration of these auxiliary additives is typically not more than 3% by weight.

The preparation of the polyester compositions of the invention may be carried out using different methods known in the art. For example, the polyester compositions are produced by melt-mixing the components, e.g., in a co-kneader or twin screw extruder, wherein the mixing temperature is in the range from 220 to 280° C. It is possible to feed all the ingredients to the extrusion throat together, but it is generally preferred to first dry-mix some of the components, and then to introduce the dry blend into the main feed port of the extruder, with one or more of the ingredients being optionally added downstream. For example, the polyester, calcium hypophosphite, the bromine containing flame retardant, one or more of the conventional additives are dry blended and the blend is fed to the extruder throat, followed by the addition of glass fibers downstream. Process parameters such as barrel temperature, melt temperature and screw speed are described in more detail in the examples that follow.

The resultant extrudates are comminuted into pellets. The dried pellets are suitable for feed to an article shaping process, injection molding, extrusion molding, compression molding, optionally followed by another shaping method. Articles molded from the polyester compositions form another aspect of the invention. Specific examples of articles include electric and electronic parts, such as connectors, circuit breakers and power plugs.

The binary mixture consisting of calcium hypophosphite and a bromine-containing polymer was shown to be effective in reducing the flammability of polyesters, such as PBT/GF₂₀₋₃₅ compositions, providing compositions having good electrical properties. Another aspect of the invention is therefore a method for preparing flame-retarded PBT/GF (e.g., PBT/GF₂₀₋₃₅) compositions, comprising processing (e.g., by melt-mixing in an extruder) PBT, glass fibers, calcium hypophosphite and bromine-containing polymer and additives as set out above, to form a PBT/GF composition with CTI above 400 V and UL 94 V-0/0.8-0.4 mm rating.

Hence, the invention also provides a method of reducing the flammability and improving the comparative tracking index (CTI) of glass-fiber reinforced poly(butylene terephthalate) composition, comprising adding an amount of bromine-containing polymer and an amount of calcium hypophosphite to the composition, wherein the composition is substantially Sb₂O₃-free. As indicated above, the amount of the bromine-containing polymer is preferably adjusted such that the bromine content of the composition is from 7.0 to 12% by weight based on the total weight of the composition, and the amount of calcium hypophosphite is preferably adjusted such that its concentration is from 5 to 10% by weight based on the total weight of the composition, wherein the composition is devoid of Sb₂O₃. Preferably, the bromine-containing polymer is poly (pentabromobenzyl acrylate) or brominated polystyrene. The method is especially adapted to produce a composition comprising from 40 to 55% by weight of PBT, from 20 to 35% by weight of glass fibers, from 5 to 10% by weight of Ca(H₂PO₂)₂, from 12 to 15% by weight of poly (pentabromobenzyl acrylate) or from 12 to 18% by weight brominated polystyrene, and from 0.1 to 1.0% by weight of polytetrafluoroethylene, based on the total weight of the composition; such that the composition achieves a UL-94 flammability test rating of V-0 at a thickness equal to 0.8 mm, and when tested in accordance with IEC 60112 standard using 0.1% by weight NH₄Cl solution and platinum electrodes, the comparative tracking index (CTI) measured is 400 V or more, e.g., greater than 420 V, for example, from 430 to 600 V, e.g., from 500 to 600 V.

### EXAMPLES

Materials and Methods

The materials used for preparing the PBT/GF₃₀ formulations are tabulated in Table 1 (FR is abbreviation of flame retardant):

TABLE 1

| Component | | |
|---|---|---|
| (manufacturer) | GENERAL DESCRIPTION | FUNCTION |
| PBT Celanex ® | Poly butylene terephthalate | Plastic matrix |
| 2500 (Ticona) | | |
| PBT 4520 (BASF) | Poly butylene terephthalate | Plastic matrix |
| GFR for PBT | Glass fibers | Reinforcing |
| (polyram) | | agent |
| FR-1025 | Poly (pentabromobenyzl acrylate) | Brominated |
| (ICL-IP) | | polymer FR |
| FR-803P | Brominated polystyrene | Brominated |
| (ICL-IP) | | polymer FR |
| F-2100 | Brominated epoxy resin | Brominated |
| (ICL-IP) | | polymer FR |
| FR-1410 | Decabromodiphenyl ethane | Non-polymeric |
| (ICL-IP) | | brominated FR |
| Ca(H₂PO₂)₂ | Calcium hypophosphite | FR |
| (Sigma Aldrich); | | |
| (Hubei Sky Lake | | |
| Chemical) | | |
| Al(H₂PO₂)₃ | Aluminum hypophosphite | FR |
| (Hubei Sky) | | |
| HDP (Example 1 of | hydroquinone bis(diphenyl | FR |
| EP 2089402; also | phosphate) | |
| available ICL-IP) | | |
| RDP | Resorcinol bis(diphenyl phosphate) | FR |
| (ICL-IP) | | |
| ATO M-0112 | Antimony trioxide (masterbatch, | FR-synergist |
| (Kafrit) | 80% w/w Sb₂O₃ content) | |
| Hostaflon ® 2711 | PTFE (Teflon) | Anti-dripping |
| (Dyneon) | | agent |
| Irganox ® 1010 | Multifunctional, nitrogen- | Antioxidant & |
| (BASF) | containing, Hindered phenol | heat stabilizer |

Flammability Properties

A direct flame test was carried out according to the Underwriters-Laboratories standard UL 94 in a gas methane operated flammability hood, applying the vertical burn on specimens of 0.8 mm or 0.4 mm thickness.

Glow Wire Ignition Temperature (GWIT) was measured according to the IEC EN 60695-2-13 method. The instrument used was the PLT Glow Wire test instrument with pulse timer type T-03-24 (3 mm thick plate).

Mechanical Properties

The Notched Izod impact test was carried out according to ASTM D256-81 using Instron Ceast 9050 pendulum impact system. Tensile properties were determined according to ASTM D638 using Zwick 1435 material testing machine (type 2 dumbbells were used, with a speed test of 5 mm/min).

Thermal Properties

Heat distortion temperature (abbreviated HDT; this is the temperature at which a polymer sample deforms under a specific load) was measured according to ASTM D-648 with load of 1820 MPa and heating rate of 120° C./hour. The instrument was HDT/VICAT-plus Daveport, Lloyd instruments.

Electrical Properties

Comparative Tracking Index (CTI) was measured according to the International Electrotechnical Commission (IEC) STANDARD publication 112 (DIN EN 60112). The test was performed with a solution of NH₄Cl 0.1% (solution A) and Pt electrodes.

### Examples 1 (Reference), 2 (Comparative), 3 (of the Invention) and 4 (Comparative)

### PBT/GF₃₀ Flame Retarded with Calcium Hypophosphite and Bromine-Containing Polymer

In this set of examples, combinations consisting of either aluminum hypophosphite or calcium hypophosphite with poly (pentabromobenyzl acrylate) were tested to determine their ability to reduce the flammability of PBT/GF₃₀ in the absence of antimony trioxide. Test specimens with thickness of 0.8 mm or 0.4 mm were prepared. In addition, mechanical, thermal and electrical properties were also measured. In the reference Example 1, a conventional recipe based on poly (pentabromobenyzl acrylate) and antimony trioxide was used. In comparative Example 4, non-polymeric brominated flame retardant was tested.

To prepare the compositions, PBT and additives (with the exception of the brominated FR and glass fibers) were premixed and the blend was fed via Feeder no. 1 into the main port of a twin-screw co-rotating extruder ZE25 with L/D=32 (Berstorff). The brominated FR was fed via Feeder no. 2 to the extruder main port. The glass fibers were added downstream, via Feeder no. 3 to the fifth zone of the barrel through a lateral feeder. Operating parameters of the extruder were as follows: Barrel temperature (from feed end to discharge end): 220° C., 250° C., 260° C., 260° C., 260° C., 265° C., 270° C., die—275° C. Screw rotation speed: 350 rpm Feeding rate: 12 kg/hour.

The strands produced were pelletized in a pelletizer 750/3 from Accrapak Systems Ltd. The resultant pellets were dried in a circulating air oven (Heraeus Instruments) at 120° C. for 4 hours. The dried pellets were injection molded into test specimens using Allrounder 500-150 from Arburg under the conditions tabulated below:

TABLE 2

| PARAMETER | Set values | |
|---|---|---|
| T₁ (Feeding zone) | 230° | C. |
| T₂ | 240° | C. |
| T₃ | 240° | C. |
| T₄ | 250° | C. |
| T₅ (nozzle) | 265° | C. |
| Mold temperature | 70° | C. |
| Injection pressure | 1000 | bar |
| Holding pressure | 850 | bar |
| Back pressure | 10 | bar |
| Holding time | 10 | s |
| Cooling time | 15 | s |
| Mold closing force | 500 | kN |
| Filling volume (portion) | 35 | ccm |
| Injection speed | 25 | ccm/sec |

Specimens of various thicknesses were prepared. The test specimens were conditioned for one week at 23° C., and were then subjected to the several tests to determine their properties. The compositions and the results are set out in Table 3.

TABLE 3

| Example | | | |
|---|---|---|---|
| Example 1 | Example 2 | | Example 4 |
| (reference) | (comparative) | Example 3 | (comparative) |

Composition

| | | | | |
|---|---|---|---|---|
| PBT (Celanex 2500) (wt %) | ~52 | ~48 | ~48 | ~50 |
| Glass fibers (wt %) | 30 | 30 | 30 | 30 |
| FR-1025 (wt %) | 11.3 | 14.1 | 14.1 | |
| (bromine, calculated) | (8) | (10) | (10) | |
| ATO M-0112 (wt %) | 6.3 | | | |
| (Sb₂O₃ wt %, calculated) | (5) | | | |
| FR-1410 | | | | 12.2 |
| (bromine, calculated) | | | | (10) |
| Al(H₂PO₂)₃ (wt %) | | 7.5 | | |
| Ca(H₂PO₂)₂ (wt %) | | | 7.5 | 7.5 |
| PTFE (wt %) | 0.3 | 0.5 | 0.5 | 0.5 |
| Irganox 1010 (wt %) | 0.2 | 0.2 | 0.2 | 0.2 |

Flammability

| | | | | |
|---|---|---|---|---|
| UL 94 V 0.8 mm | V-0 | V-0 | V-0 | V-2 |
| UL 94 V 0.4 mm | V-0 | V-0 | V-2 | V-2 |
| GWIT (° C.) | 750 | 900 | 900 | ND |

Mechanical properties

| | | | | |
|---|---|---|---|---|
| Izod notched impact(J/m) | 77 | 49 | 60 | ND |
| Tensile modulus (MPa) | 11,567 | 13,293 | 13,535 | ND |
| Tensile strength (MPa) | 125 | 109 | 115 | ND |
| Elongation at break (%) | 3% | 2% | 2% | ND |

Thermal properties

| | | | | |
|---|---|---|---|---|
| HDT (° C.) | 200 | 202 | 199 | ND |

Electrical properties

| | | | | |
|---|---|---|---|---|
| CTI (V) | 275 | 250 | 450 | ND |

The results set out in Table 3 indicate the high efficacy of a combination consisting of a metal hypophosphite salt and poly (pentabromobenyzl acrylate) in reducing the flammability of thin PBT/GF₃₀ test specimens, achieving UL 94 V-0/0.8 mm rating and high GWIT values. Additionally, PBT/GF₃₀ flame retarded with a metal hypophosphite and poly (pentabromobenyzl acrylate) displays fairly good mechanical and thermal properties. Notably, poly (pentabromobenyzl acrylate)/calcium hypophosphite mixture emerges as a useful flame retarded additive in PBT/GF₃₀, seeing that the formulation exhibits high CTI.

On the other hand, a non-polymeric bromine-containing flame retardant tested (FR-1410; decabromodiphenyl ethane, a flame retardant containing 82% aromatic bromine, which is considered the additive of choice for a large variety of applications, including PBT) was shown to be unsuitable, seeing that the combination FR-1410/calcium hypophosphite failed to gain UL V-0/0.8 mm rating. It appears that in the case of decabromodiphenyl ethane, calcium hypophosphite is unable to offset the absence of antimony trioxide.

### Examples 5-9

### PBT/GF₃₀ Flame Retarded with Calcium Hypophosphite and Bromine-Containing Polymer

As shown in this set of examples, apart from poly (pentabromobenyzl acrylate), other bromine-containing polymers available in the market can be combined with calcium hypophosphite to achieve PBT/GF₃₀ compositions that are UL 94 V-0/0.8-0.4 mm rated.

To prepare the compositions, PBT and the additives as set out in Table 4 below were fed into a twin-screw extruder under processing conditions described in the previous set of Examples to produce 0.8 mm and 0.4 mm thick test specimens. Specimens were then tested to determine fire behavior, mechanical, thermal and/or electrical properties. Compositions and results are tabulated below.

TABLE 4

| Example | | | | |
|---|---|---|---|---|
| Example | Example | Example | Example | Example |
| 5 | 6 | 7 | 8 | 9 |

Composition

| | | | | | |
|---|---|---|---|---|---|
| PBT (Celanex 2500)(wt %) | ~50 | ~47 | ~46 | ~43 | |
| PBT (BASF 4520) (wt %) | | | | | ~47 |
| Glass fibers (wt %) | 30 | 30 | 30 | 30 | 30 |
| Ca(H₂PO₂)₂ (wt %) | 7.5 | 7.5 | 7.5 | 7.5 | 7.5 |
| FR-803P (wt %) | 12.1 | 15.2 | | | 15.2 |
| (bromine wt %, calculated) | (8) | (10) | | | (10) |
| F-2100 (wt %) | | | 15.4 | 19.2 | |
| (bromine, calculated) | | | (8) | (10) | |
| PTFE (wt %) | 0.5 | 0.5 | 0.5 | 0.5 | 0.5 |
| Irganox 1010 (wt %) | 0.2 | 0.2 | 0.2 | 0.2 | 0.2 |

Flammability

| | | | | | |
|---|---|---|---|---|---|
| UL 94 V 0.8 mm | V-1 | V-0 | V-0 | V-0 | ND |
| UL 94 V 0.4 mm | V-0 | V-0 | V-2 | V-0 | ND |
| GWIT (° C.) | 750 | 775 | 900 | 900 | ND |

Mechanical properties

| | | | | | |
|---|---|---|---|---|---|
| Izod notched impact (J/m) | 75 | 72 | 71 | 73 | ND |
| Tensile modulus (MPa) | 10666 | 11347 | 11686 | 12635 | ND |
| Tensile strength (MPa) | 116 | 114 | 136 | 138 | ND |
| Elongation at break (%) | 3.5 | 3.3 | 3.2 | 2.9 | ND |

Thermal properties

| | | | | | |
|---|---|---|---|---|---|
| HDT (° C.) | 197 | 194 | 192 | 180 | ND |

Electrical properties

| | | |
|---|---|---|
| CTI (V) | 525 | 600 |

### Examples 10-11

### PBT/GF₃₀ Flame Retarded with Bromine-Containing Polymer, Calcium Hypophosphite and Phosphate Ester

In this set of examples, the bromine-containing polymer was applied in conjunction with calcium hypophosphite and phosphate ester flame retardant. Two types of the phosphate ester flame retardants were tested: HDP, available from ICL-IP as free flowing solid pastilles, and RDP, available from ICL-IP as clear transparent liquid (Fyrolflex™ RDP). RDP can be used as is in compounding processes, e.g., by feeding the liquid into an extruder through a downstream port using a pump. However, in the experiments reported herein, RDP was first formulated into masterbatch pellets in PBT as carrier; the so-formed pellets were subsequently employed to prepare the compositions of the invention via compounding in a co-rotating twin-screw extruder, with test specimens produced by injection molding, as described in previous examples. Compositions and test results are set out in Table 5.

TABLE 5

| | | |
|---|---|---|
| Example | Example 10 | Example 11 |

Composition

| | | |
|---|---|---|
| PBT (Celanex 2500) (wt %) | ~48 | ~12 |
| Glass fibers (wt %) | 30 | 30 |
| FR-1025 (wt %) | 14.1 | 14.1 |
| (bromine, calculated) | (10) | (10) |
| Ca(H₂PO₂)₂ (wt %) | 2.5 | 2.5 |
| HDP | 5.0 | |
| RDP as masterbatch in PBT, 12.5% wt RDP | | 40.7 |
| (RDP, calculated) | | (5) |
| PTFE (wt %) | 0.5 | 0.5 |
| Irganox 1010 (wt %) | 0.2 | 0.2 |

Flammability

| | | |
|---|---|---|
| UL 94 V 1.6 mm | V-0 | V-0 |
| UL 94 V 0.8 mm | V-0 | V-0 |
| UL 94 V 0.4 mm | V-2 | V-2 |

Mechanical properties

| | | |
|---|---|---|
| Izod notched impact (J/m) | 57 | 64 |
| Tensile modulus (MPa) | 13243 | 10856 |
| Tensile strength (MPa) | 99 | 111 |
| Elongation at break (%) | 3.0 | 3.5 |

Thermal properties

| | | |
|---|---|---|
| HDT (° C.) | 191 | 194 |

1. A composition comprising polyester and a mixture of flame retardants having at least the following two components:
calcium hypophosphite and bromine-containing polymer.

2. A composition according to claim 1, which is free of antimony trioxide.

3. A composition according to claim 1, wherein the polyester is poly (butylene terephthalate) (PBT).

4. A composition according to claim 1, which further comprises reinforcing filler.

5. A composition according to claim 4, wherein the reinforcing filler comprises glass fibers, with the concentration of the glass fibers in the composition being from 10 to 40% by weight, based on the total weight of the composition.

6. A composition according to claim 5, comprising PBT reinforced with glass fibers at a concentration of 20 to 35 by wt % based on the total weight of the composition.

7. A composition according to claim 1, wherein the bromine-containing polymer is selected from the group consisting of:
i) poly (pentabromobenzyl acrylate);
ii) brominated polystyrene; and
iii) brominated epoxy resins and end-capped derivatives thereof, represented by the Formula (I): 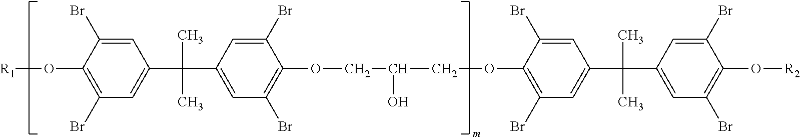
wherein m indicates the degree of polymerization and Ri and R2 are independently selected from the group consisting of:

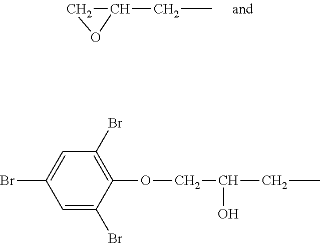

8. A composition according to claim 7, comprising PBT, glass fibers, calcium hypophosphite, poly (pentabromobenzyl acrylate) and polytetrafluoroethylene.

9. A composition according to claim 8, comprising from 40 to 55% by weight of PBT, from 20 to 35% by weight of glass fibers, from 5 to 10% by weight of Ca(H₂PO₂)₂, from 12 to 15% by weight of poly (pentabromobenzyl acrylate) and from 0.1 to 1.0% by weight of polytetrafluoroethylene, based on the total weight of the composition.

10. A composition according to claim 7, comprising PBT, glass fibers, calcium hypophosphite, brominated polystyrene and polytetrafluoroethylene.

11. A composition according to claim 10, comprising from 40 to 55% by weight of PBT, from 20 to 35% by weight of glass fibers, from 5 to 10% by weight of Ca(H₂PO₂)₂, from 12 to 18% by weight of brominated polystyrene and from 0.1 to 1.0% by weight of polytetrafluoroethylene, based on the total weight of the composition.

12. A composition according to claim 7, comprising PBT, glass fibers, calcium hypophosphite, brominated epoxy resin of the formula 1a: 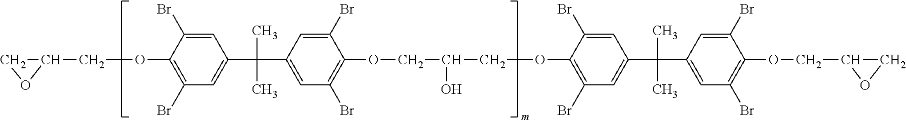
with weight-average molar mass between 15000 and 25000, and polytetrafluoroethylene.

13. A composition according to claim 12, comprising from 40 to 50% by weight of PBT, from 20 to 35% by weight of glass fibers, from 5 to 10% by weight of Ca(H₂PO₂)₂, from 15 to 20% by weight of brominated epoxy resin of the formula 1a: 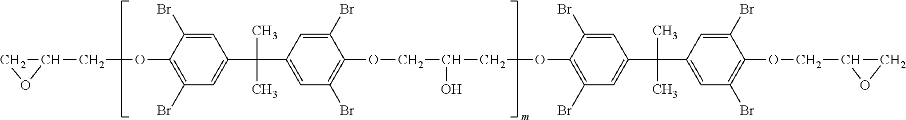
and from 0.1 to 1.0% by weight of polytetrafluoroethylene, based on the total weight of the composition.

14. A composition according to claim 1, characterized in that it achieves a UL-94 flammability test rating of V-0 at a thickness equal to 0.8 mm, and when tested in accordance with IEC 60112 standard using 0.1% by weight NH₄Cl solution and platinum electrodes, the comparative tracking index (CTI) measured is 400 V or more.

15. A process for preparing flame-retarded glass-fiber reinforced poly (butylene terephthalate) composition as defined in claim 1, comprising processing poly (butylene terephthalate), glass fibers, calcium hypophosphite and at least one bromine-containing polymer, to form a composition with CTI above 400 V and UL 94 V-0/0.8 mm rating, wherein the process is devoid of addition of antimony trioxide.

16. A method of reducing the flammability and improving the comparative tracking index (CTI) of glass-fiber reinforced poly (butylene terephthalate) composition, comprising adding an amount of bromine-containing polymer and an amount of calcium hypophosphite to the composition, wherein the composition is substantially Sb₂O₃-free.

17. A method according to claim 16, wherein the amount of the bromine-containing polymer is adjusted such that the bromine content of the composition is from 7.0 to 12% by weight based on the total weight of the composition, and the amount of calcium hypophosphite is adjusted such that its concentration is from 5 to 10% by weight based on the total weight of the composition.

18. A method according to claim 16, wherein the bromine-containing polymer is poly (pentabromobenzyl acrylate).

19. A method according to claim 18, such that the composition comprises from 40 to 55% by weight of PBT, from 20 to 35% by weight of glass fibers, from 5 to 10% by weight of Ca(H₂PO₂)₂, from 12 to 15% by weight of poly (pentabromobenzyl acrylate) and from 0.1 to 1.0% by weight of polytetrafluoroethylene, based on the total weight of the composition.

20. A method according to claim 16, wherein the bromine-containing polymer is brominated polystyrene.

21. A method according to claim 20, such that the composition comprises from 40 to 55% by weight of PBT, from 20 to 35% by weight of glass fibers, from 5 to 10% by weight of Ca(H₂PO₂)₂, from 12 to 18% by weight of brominated polystyrene and from 0.1 to 1.0% by weight of polytetrafluoroethylene, based on the total weight of the composition.

22. A method according to claim 16, such that the composition achieves a UL-94 flammability test rating of V-0 at a thickness equal to 0.8 mm, and when tested in accordance with IEC 60112 standard using 0.1% by weight NH₄Cl solution and platinum electrodes, the comparative tracking index (CTI) measured is 400 V or more.

23. An article molded from the composition of claim 1.
